(19) United States
(12) Patent Application Publication
(10) Pub. No.: US 2011/0125481 A1
(43) Pub. Date: May 26, 2011

(54) APPARATUS AND METHOD FOR SIMULATING FUNCTION OF MULTIMEDIA DEVICE

(76) Inventors: Chih Ching CHIEN, Hsin Chu County (TW); Shuang-xi Chen, Su State (CN)

(21) Appl. No.: 12/950,427

(22) Filed: Nov. 19, 2010

(30) Foreign Application Priority Data
Nov. 20, 2009 (TW) 098139532

(51) Int. Cl. G06F 9/455

(52) U.S. Cl. 703/21

(57) ABSTRACT

A non-multimedia device having functions of simulating a multimedia device and a simulating method thereof are disclosed in the present invention. The non-multimedia device includes a control chip, a host interface and a memory interface. The control chip controls the operation of the non-multimedia device. The host interface is connected with a host as a communication interface between the host and the non-multimedia device. The memory interface is connected with a memory card as a communication interface between the memory card and the non-multimedia device.

This application claims the benefit of Taiwan application Serial No. 098139532, filed on Nov. 20, 2009, the subject matter of which is incorporated herein by reference.

### BACKGROUND OF THE INVENTION

(a) Field of the Invention

The invention relates to non-multimedia device for simulating a function of multimedia device.

(b) Description of the Related Art

In the modern life, everyone is in contact with a variety of electronic products in his daily life. Currently, the development trend of electronic products is to be convenient and portable.

A CD/DVD player is not suitable in portability due to its bulky and weighty. A CD/DVD player slows down if the function is enhanced and besides an optical disc/disk can be damaged easily. However, it is an advantage of being convenient for a personal computer (PC) having a CD/DVD ROM while an operating system (OS) is to be installed. Thus, a CD/DVD ROM is always equipped in a computer as a standard peripheral.

Besides, a memory card, such as a SD card or a card of Memory Stick Pro series, is extensively used and its capacity becomes larger and larger nowadays. Compared to an optical disc/disk that can be damaged or scratched easily, a memory card has the distinctive features of longer lifetime and being vibration-proof. Furthermore, compared to a USB card reader or PCI-E card reader, an optical disc/disk player is expansive, bulky and is not vibration-proof and falling-proof because of a built-in optical head of CD/DVD player.

USB (universal serial bus) or PCI or PCI-E has become the most popular external I/O after developed over years. Each computer has USB or PCI or PCI-E interface. A memory storage device such as a memory flash drive and a USB card reader become more popular because of good functionality, portable convenience, etc.

Therefore, in view of the above problems in the prior art, the inventors tend to utilize a card reader (such as USB card reader, PCI or PCI-E card reader or other card readers with other interfaces) having a computer interface to simulate the read/write functions of an optical disc/disk player and besides maintains the advantages of an optical disc/disk player such as a function of installing an operating system to thereby improve the demerits in the prior art.

### BRIEF SUMMARY OF THE INVENTION

One object of the invention is to provide a device for simulating a multimedia function of a multimedia device to thereby improve the demerits in the prior art.

One object of the invention is to provide a device for simulating a multimedia function of a multimedia device, capable of conveniently installing software (such as an operating system).

The invention provides a method for making a device without a multimedia function (such as USB card reader, USB flash drive, or the like) simulate a device with multimedia function (such as a USB CD/DVD ROM).

One embodiment of the invention provides a device without a multimedia function. The non-multimedia device comprises a control chip, a host interface and a memory interface. The control chip controls the operation of the non-multimedia device. The host interface is connected with a host as a communication interface between the host and the non-multimedia device. The memory interface is connected with a memory card as a communication interface between the memory card and the non-multimedia device. While the control chip is in operation, the host is notified that the non-multimedia device is a multimedia device.

One embodiment of the invention provides a method for making a non-multimedia device simulate a multimedia device. The non-multimedia device comprises a control chip, a host interface and a memory interface. The method comprises: using the host interface to connect with a host; using the control chip to notify the host that the non-multimedia device is a multimedia device; and using an exclusive command block wrapper (CBW) by the host to request data transmission with the non-multimedia device, after the host is notified that the non-multimedia device is a multimedia device.

### BRIEF DESCRIPTION OF THE DRAWINGS

FIG. 1 shows a schematic diagram illustrating implementation concept of a non-multimedia device according to the invention.

FIG. 2 shows a flow chart illustrating a processing flow of the non-multimedia device based on the Bulk-Only Transport Protocol according to one embodiment of the invention.

FIG. 3 shows a flow chart illustrating an implementing flow that the computer host makes the non-multimedia device of the invention simulate an optical disc/disk player.

FIG. 4 shows a flow chart illustrating implementation of making the non-multimedia device simulate an optical disc/disk player to read a DVD-R disc/disk according to one embodiment of the invention.

FIG. 5 shows a flow chart illustrating implementation of making the non-multimedia device simulate an optical disc/disk player to write a DVD-R disc/disk according to one embodiment of the invention.

FIG. 6 shows a schematic diagram illustrating the non-multimedia device having the functions of an original card reader and also the functions of simulating a CD/DVD disc/disk player according to one embodiment of the invention.

### DETAILED DESCRIPTION OF THE INVENTION

The present invention will be described in details with reference to the drawings through the following embodiments to enable one of ordinary skill in the art to implement the present invention but the implementation of the present invention is not limited by the following embodiments.

The invention provides a method for making a USB storage device including a USB card reader (or USB flash drive) simulate a USB CD/DVD disc/disk player. The invention provides a USB capable of reading and/or writing CD/DVD disc/disk data format or a peripheral command (PCI-E) storage device (such as card reader or the like) to possess the advantages of not only a conventional optical disc/disk player but also a conventional USB or PCI-E storage device (such as card reader or the like).

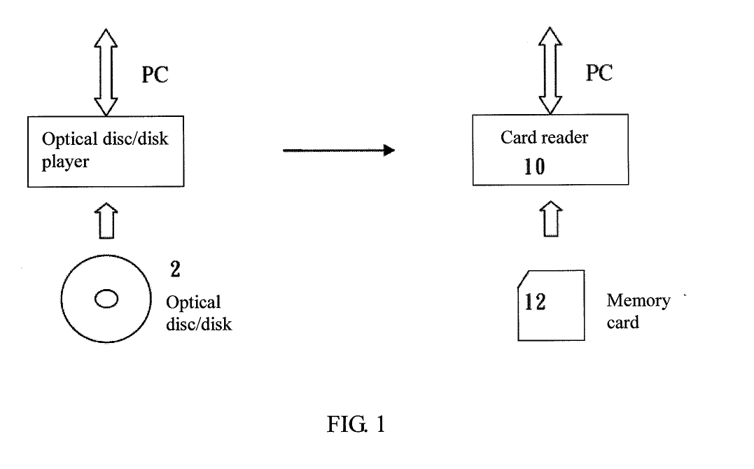

The spirit of the invention is to make a device without a multimedia function simulate a device with the multimedia function. For examples, a USB memory card reader simulates an optical disc/disk player while a memory card simulates an optical disc/disk. FIG. 1 shows a schematic diagram illustrating implementation concept of a non-multimedia device according to the invention. As shown in FIG. 1, for upper layer programs (application software) such as Nero burning program, Power DVD and the like, the effect of the non-multimedia device according to the invention is the same as that of a real optical disc/disk player. In an embodiment, the non-multimedia device 10 comprises a control chip, a host interface and at least one memory interface. The control chip controls the operation of the non-multimedia device 10. The host interface is connected with a host (such as PC in FIG. 1) as a communication interface between the host and the non-multimedia device 10. The memory interface is connected with a memory card 12 as a communication interface between the memory card 12 and the non-multimedia device 10. While the control chip is in operation, the host is notified that the non-multimedia device is a multimedia device. The control chip (for examples: card reader controller, USB control circuit, ASIC, micro-controller, etc) of the non-multimedia device 10 has a first interface (i.g. a USB interface circuit) which is connected to the host interface and a second interface which is connected to the memory interface.

As for drivers, USB standard categorizes various devices to make each category have its own driver for management convenience. A USB optical disc/disk player and a USB storage device both belong to mass storage class and thus the driver will not be affected when a USB storage device simulates a USB optical disc/disk player. Therefore, a device maker does not need to alter the driver on the computer. Also, a USB storage device can simulate a USB optical disc/disk player according to the design of the invention so that a memory card can simulate an optical disc/disk to store data with CD/DVD format to thereby use the CD/DVD format to boot up for installing an operating system.

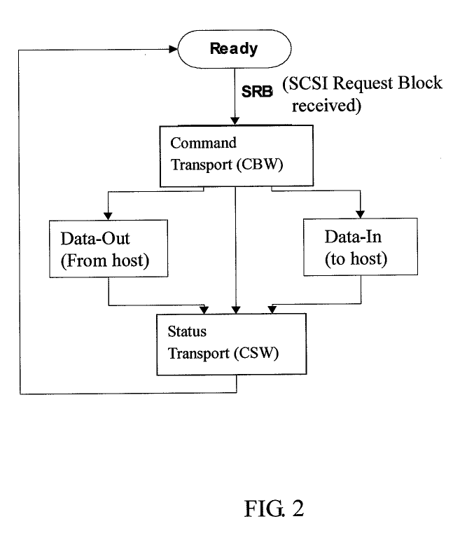

The commonly seen USB mass storage protocol is the Bulk-Only Transport (BOT) protocol and it not only can be implemented easily but also provides a high transmission rate. Since the Bulk-Only Transport (BOT) protocol is well known to one of ordinary skill in the art, its details will not be given hereinafter. It can be referred to “USB Implementers Forum, Universal Serial Bus Mass Storage Class Bulk-Only Transport, Revision 1.0, Dec. 14, 1998”. The processing flow of the Bulk-Only Transport (BOT) protocol is also called “command/data/status flow”. As shown in FIG. 2, the processing flow of the Bulk-Only Transport (BOT) protocol is illustrated. The flow is described as follows. When the host receives an operating request on a mass storage device (device) from an application program, the request is packeted as a command block wrapper (CBW) and sent to the device through a “USB Bulk-Out transaction” operation. If the request includes data transmission, the “Data-In” or “Data-Out” transmission is performed. Otherwise, directly passing the “Bulk-In transaction” operation, a command status wrapper (CSW) is to be received to determine whether the request is succeeded or not. When the host interface of the device is another interface, the corresponding protocol need to be used.

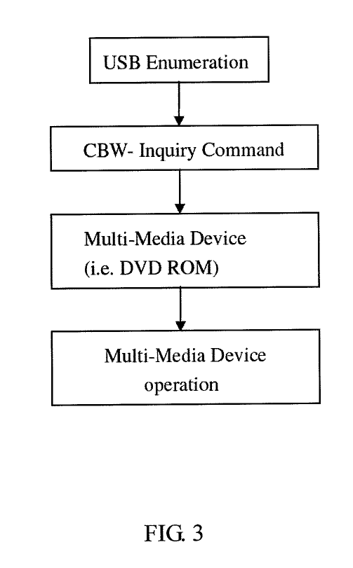

FIG. 3 shows one implementation method that the computer makes the non-multimedia device according to the invention simulate an optical disc/disk player. Referring to FIG. 3, after “USB Enumeration” is complete, the host acquires the parameters and status of the USB device through sending out the CBW through the BOT protocol. According to the messages and the request from the upper layer programs, different CBWs are sent out to achieve the purpose of data transmission between the host and the device. When the host is used to send an inquiry command (0x12), the host is notified that the non-multimedia device is a multimedia device according to the multimedia device standard, that is, the host is notified that the non-multimedia device is an optical disc/disk player. When the host recognizes the current device as an optical disc/disk player, the host starts to use an exclusive CBW to request data transmission with this device. Thus, this method is used to perform data transmission with CD/DVD format so as to simulate an optical disc/disk player. The implementation process of making a USB card reader supporting SD card (Secure Digital Card) simulate an optical disc/disk player supporting DVD-ROM and DVD-R optical discs/disks is used as an example.

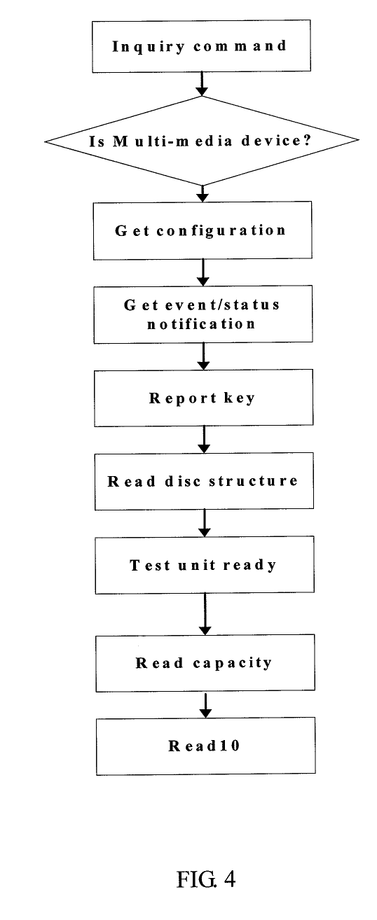

FIG. 4 shows a flow chart illustrating implementation of making the non-multimedia device simulate an optical disc/disk player to read a DVD-R disc/disk according to one embodiment of the invention. At first, when the host recognizes the non-multimedia device as a multimedia device, the host acquires the basic capability of the optical disc/disk player by performing a “Get configuration” operation and also performs a “Get event/status notification” operation to inquire the status of the device and what is to be processed for the device. Then, “Report key” and “read disc/disk structure” operations are performed to acquire the further information and whether an optical disc/disk is in the optical disc/disk player or not is determined from “Test unit ready”. At the time, if a SD card exists, it is replied that “Test unit ready” is successful so that the host considers that an optical disc/disk is in the optical disc/disk player. Following that, the host performs a “Read capacity” operation to acquire the capacity information and a “Read” operation to read data.

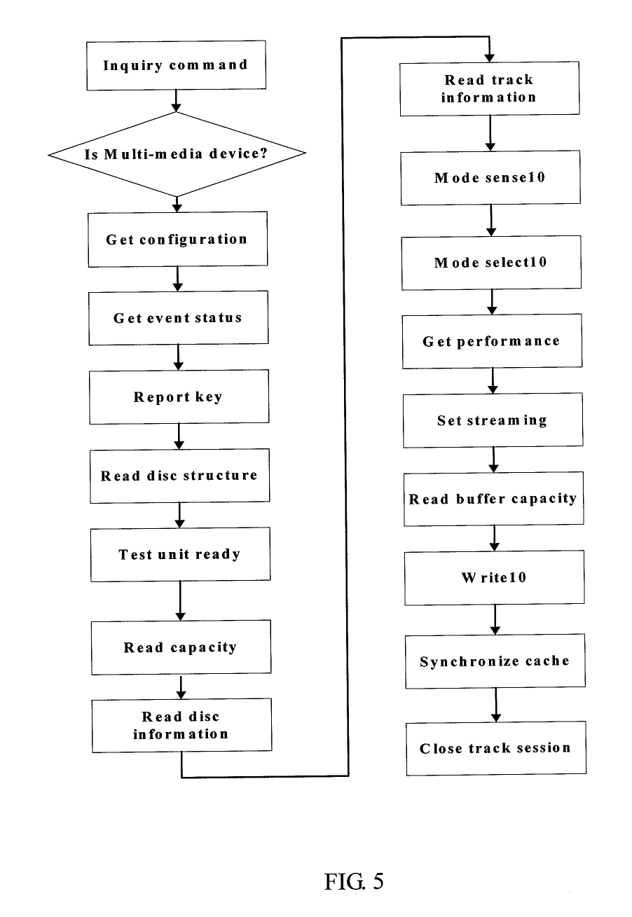

FIG. 5 shows a flow chart illustrating implementation of making the non-multimedia device simulate an optical disc/disk player to write a DVD-R disc/disk according to one embodiment of the invention. In the previous example, the process of recognizing an optical disc/disk is the same as that of reading the optical disc/disk. After the application program performs a “write” request, the host reads the corresponding parameters of the disc/disk by performing “Read disc/disk information”, “Read track information”, and “Mode sense” operations and sets the parameters by performing a “Mode select” operation. Then, the host acquires the writing speed and the buffer size by performing “Get performance”, “Set stream”, and “Read buffer capacity” operations. Finally, the “Write” command can be written into the disc/disk. At the time, the command is actually written into the card. After all data are written, this “write” operation is finished through “synchronize cache” and “Close track session”.

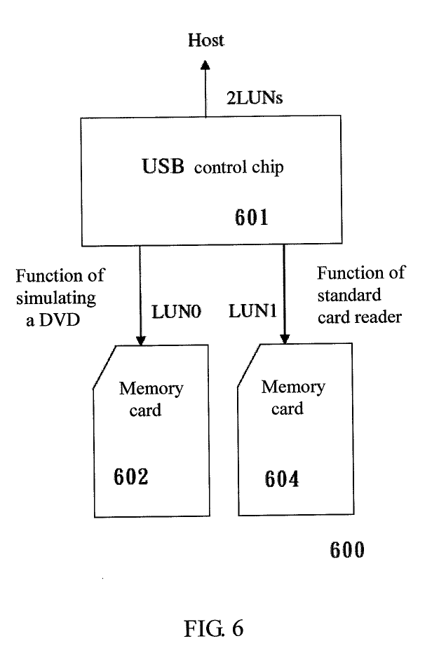

Furthermore, the function of simulating DVD and the functions of reading and writing a memory card for a conventional card reader can be all designed in one single device. Using the method that USB mass storage class can declare a plurality of logic unit numbers (LUN), a LUN can be designated to a standard card reader function and the other LUN can be designated to a multimedia device function. FIG. 6 shows a schematic diagram illustrating the non-multimedia device having the functions of an original card reader and also the functions of simulating a CD/DVD disc/disk player according to one embodiment of the invention. In FIG. 6, the card reader 600 are declared with a plurality of logic unit numbers (LUN), one of which is a standard card reader function and the other of which is a multimedia device function. The card reader 600 comprises a card reader control chip 601 to control the operation of the card reader 600 and to implement the related technique of the invention to make the card reader 600 simulate an optical disc/disk player and make a first memory card 602 simulate a disc/disk; a host interface (such as USB interface, PCI interface, PCI-E interface or other current or future interfaces), connected with the host, for communication between the host and the control chip 601; two memory interfaces (such as secure digital card (SD), multimedia card (MMC), MSPRO, compact flash (CF), or other current or future memory interfaces), separately connected with the related memory card (such as the memory cards 602 and 604 in FIG. 6), for communication between the memory card and the control chip 601.

Although the present invention has been fully described by the above embodiments, the embodiments should not constitute the limitation of the scope of the invention. Various modifications or changes can be made by those who are skilled in the art without deviating from the spirit of the invention.

What is claimed is:

1. A non-multimedia device, comprising:
a control chip to control the operation of the non-multimedia device;
a host interface, coupled to a host, for communication between the host and the control chip; and
a memory interface, coupled to a memory device, for communication between the memory device and the control chip;
wherein the host is notified that the non-multimedia device is a multimedia device while the control chip is in operation.

2. The device according to claim 1, wherein the host uses an exclusive command block wrapper (CBW) to request data transmission with the non-multimedia device, after the host is notified that the non-multimedia device is a multimedia device.

3. The device according to claim 1, wherein the host receives a command status wrapper (CSW) transmitted by the non-multimedia device to acquire the status of the device so as to determine whether a request from the host is succeeded or not.

4. The device according to claim 1, wherein the non-multimedia device treats the memory device as an optical disc/disk to store data with multimedia device format or uses the multimedia device format to boot up for installing an operating system.

5. The device according to claim 1, further comprising:
a second memory interface, coupled to a second memory device, for communication between the second memory device and the control chip, wherein the second memory card has the function of a memory card.

6. The device according to claim 5, wherein the non-multimedia device are declared with a plurality of logic unit numbers.

7. The device according to claim 6, wherein one of the logic unit numbers is a standard card reader function and the other one of which is a multimedia device function.

8. A method for making a non-multimedia device simulate a multimedia device, the method comprising:
using a host interface to couple to a host; and
notifying the host that the non-multimedia device is a multimedia device such that the non-multimedia device has at least one of functions of the multimedia device.

9. The method according to claim 8, further comprising:
using an exclusive command block wrapper (CBW) by the host to request data transmission with the non-multimedia device, after the host is notified that the non-multimedia device is a multimedia device.

10. The method according to claim 8, wherein the non-multimedia device is a card reader.

11. The method according to claim 10, wherein the card reader comprises a memory interface, coupled to a memory card.

12. The method according to claim 11, wherein the card reader treats the memory card as an optical disc/disk to store data with multimedia device format or uses the multimedia device format to boot up for installing an operating system.

13. A non-multimedia apparatus for simulating a multimedia function of a multimedia device, the circuit comprising:
a host interface, coupled to a host, for communication between the host and the apparatus; and
a memory interface, coupled to a memory device, for communication between the memory device and the apparatus;
wherein the host is notified that the non-multimedia apparatus is the multimedia device.

14. The apparatus according to claim 13, wherein the apparatus declares that the apparatus has a plurality of logic unit numbers.

15. The apparatus according to claim 14, wherein one of the logic unit numbers is a non-multimedia device function and the other one of which is a multimedia device function.
